(19) United States
(12) Patent Application Publication
(10) Pub. No.: US 2009/0276096 A1
(43) Pub. Date: Nov. 5, 2009

(54) DEVICE AND METHOD FOR CONTROLLING A DISPLAY USING A VIRTUAL DISPLAY BUFFER

(75) Inventors: Jerry L. Proffitt, Wabash, IN (US); Laurie L. Werbowsky, Jamesville, NY (US); Tim Comerford, Indianapolis, IN (US); Chad A. Powell, Marion, IN (US)

Correspondence Address: KINNEY & LANGE, P.A., THE KINNEY & LANGE BUILDING, 312 SOUTH THIRD STREET, MINNEAPOLIS, MN, 55415-1002, US

(73) Assignee: CARRIER CORPORATION, Farmington, CT (US)

(21) Appl. No.: 12/426,640

(22) Filed: Apr. 20, 2009

Related U.S. Application Data
(60) Provisional application No. 61/126,234, filed on May 2, 2008.

(51) Int. Cl. G05B 13/00; G09G 5/36

(52) U.S. Cl. 700/278; 345/560

(57) ABSTRACT

A device and a method for controlling a display make use of a virtual display buffer that acts as an intermediary between data input and display output. The data stored in the virtual display buffer is in a generic, readable first format. A display software driver translates the data stored in the virtual display buffer to a second format usable by a hardware display driver to control a specific display device.

### CROSS-REFERENCE TO RELATED APPLICATION

This application claims the benefit of U.S. Provisional Application No. 61/126,234 filed May 2, 2008, which is hereby incorporated by reference.

### BACKGROUND

Thermostats are typically provided for controlling a heating and/or cooling system within a building. A thermostat regulates temperature by turning on and off heating and/or cooling systems to achieve a predetermined temperature. A typical thermostat includes a temperature sensor, which determines whether the heating or cooling systems should be turned on or off to arrive at the predetermined temperature.

A thermostat may include a display for displaying information such as current indoor temperature, outdoor temperature, time, date, day of the week, heating set point, and cooling set point. Thermostat displays may also provide a variety of information through icons such as an on/off indicator, a fan mode indicator, a Fahrenheit/Celsius indicator, a battery strength indicator, a sleep mode indicator, AM/PM indicator, and a hold indicator. As the amount of information provided by the thermostat display increases, the need to manage display data increases.

Thermostat displays that display more than indoor temperature often use a liquid crystal display (LCD). It is known to use a display software driver to control how information will be displayed on the LCD. Generally, temperature is sensed with an ambient condition sensor and the sensed temperature is sent to a display software driver. Additional data may be inputted through a user interface or thermostat applications. The display software driver formats the data for a specific LCD and sends the formatted data to the hardware display driver, which physically turns on or off display symbols on the LCD. Because the display software driver formats data specifically for a particular LCD, it is difficult to understand the display symbols outside of the specific LCD context. If a particular LCD has not been chosen, the software cannot be written. Worse yet, if the LCD is changed, the software must be completely rewritten. The inability to understand display symbols outside of a specific LCD context can be problematic for engineers who need to develop and debug display software.

### SUMMARY

Exemplary embodiments of the invention include a device, which comprises one or more input devices, a microprocessor, a display hardware driver, and a display. The microprocessor may be configured to process an application which receives inputted data, a virtual buffer for buffering data in a first format, and a display software driver for translating the data from the first format to a second format. The display hardware driver receives data in the second format and controls the display to display one or more symbols based on the data.

In addition, exemplary embodiments of the invention include a method of controlling a display. The method comprises gathering data from one or more inputs, buffering data in a first format, translating data from the first format to a second format, and communicating the data in the second format to the display to display one or more symbols based on the data.

### BRIEF DESCRIPTION OF THE DRAWINGS

FIG. 1 is a perspective view of the exterior of a thermostat.

FIG. 2 is a block diagram of a thermostat using a virtual display buffer.

FIG. 3 is a block diagram of a method of controlling a thermostat display.

FIG. 4 is a plan view of a thermostat display and touch sensitive buttons.

### DETAILED DESCRIPTION

The present invention is described in the context of a thermostat display. It should be understood that the invention is not limited to a thermostat display and is applicable to any device with a display.

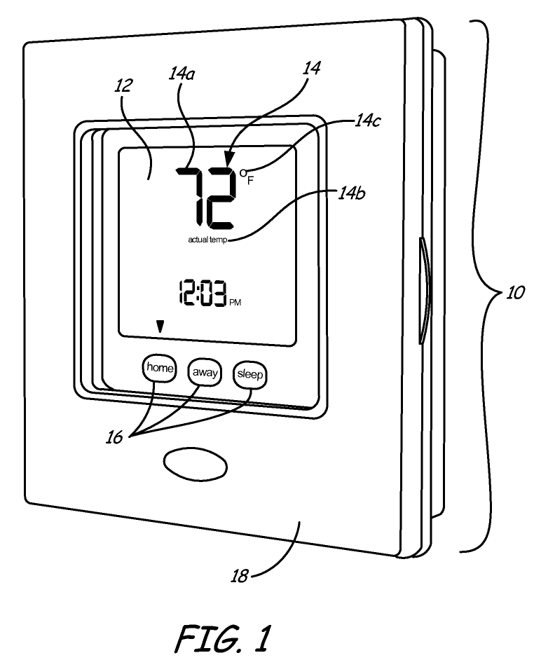

FIG. 1 is a perspective view of the exterior of a thermostat. FIG. 1 depicts thermostat 10 including display 12 for posting symbols 14, a plurality of touch sensitive buttons 16, and casing 18. Symbols 14 may include seven-segment display characters 14a, alpha-numeric characters 14b, and/or icons 14c. Symbols 14 may represent ambient and system conditions such as outdoor temperature, time, date, day of the week, heating set point, cooling set point, on/off indicator, fan mode indicator, Fahrenheit/Celsius indicator, battery strength indicator, a sleep mode indicator, AM/PM indicator, and a hold indicator.

Generally, a user may apply pressure to touch sensitive buttons 16 to toggle the functions and modes of thermostat 10. Symbols 14 on display 12 will change in response to inputs from a user interface, such as touch sensitive buttons 16. When in a default thermostat mode, display 12 of thermostat 10 will commonly display current indoor ambient temperature in seven-segment display characters 14a. Alpha-numeric characters 14b may display words such as “actual temp” and “PM” thereby clarifying what the seven-segment display characters 14a represent. Also, icons 14c may be present on display 12 to indicate such things as whether the temperature is degrees Celsius or Fahrenheit. In this manner, a plurality of symbols 14 on display 12 of thermostat 10 relay thermostat information to a user.

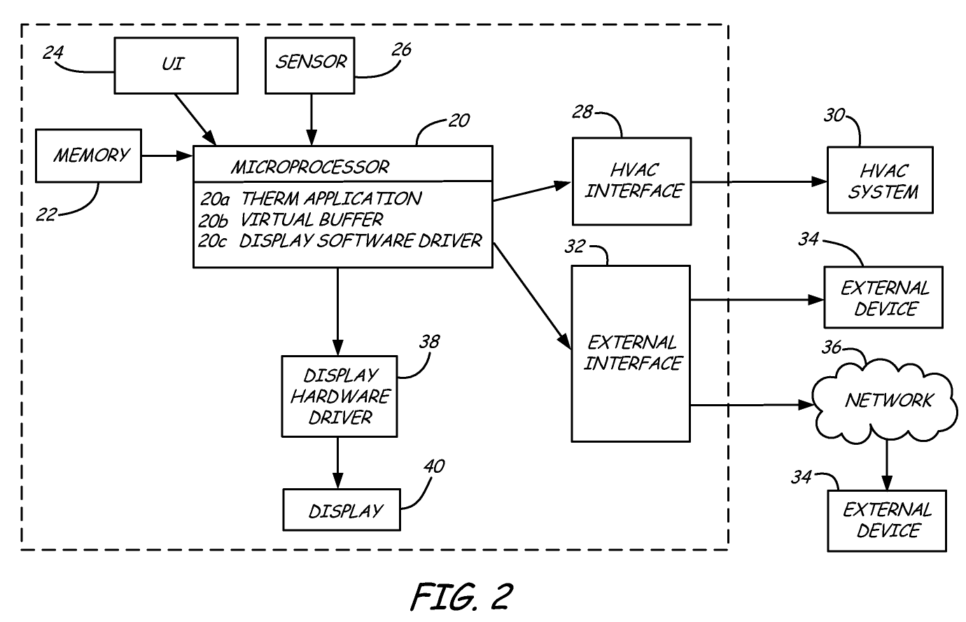

FIG. 2 is a block diagram of a thermostat using a virtual display buffer (20b). Microprocessor 20 receives data from one or more inputs. In FIG. 2, there are three inputs shown: memory 22, user interface (UI) 24, and sensor 26. Microprocessor 20 processes data and communicates data to interface 28 (which in this case is a heating, ventilation, and air conditioning (HVAC) interface), external interface 32, and display hardware driver 38. HVAC interface 28 uses data to communicate with HVAC system 30. External interface 32 uses data to communicate with external device 34 and/or network 36. Display hardware driver 38 uses data to control display 40, which results in a thermostat display similar to FIG. 1.

The use of any suitable memory, such as flash memory or EEPROM memory, is within the scope of this invention. Memory 22 may contain stored settings such as set points for heating/cooling, general thermostat programming, or special alerts like “replace filter”. Memory 22 may be separated from and electrically connected to microprocessor 20 or may be embedded on board microprocessor 20. User interface 24 may be any sort of user interface which allows a user to communicate with the microprocessor. Touch sensitive buttons 16 of FIG. 1 are one example of user interface 24. Sensor 26 may be an ambient condition sensor capable of sensing indoor temperature, outdoor temperature, humidity and the like.

Microprocessor 20 includes a plurality of programs including at least thermostat application 20a, virtual display buffer 20b, and display software driver 20c. Thermostat application 20a is configured to gather data and communicate data to HVAC interface 28, which controls HVAC system 30. Thermostat application 20a also sends data to virtual display buffer 20b. Virtual display buffer 20b is configured to buffer data in a first format, which is highly generic and readable by many applications. Virtual display buffer 20b may send data in the first format to display software driver 20c and/or external interface 32. Display software driver 20c translates the data from the first format to a second format specific to the thermostat display 40. Data in the second format is sent to display hardware driver 38, which turns on and off the specific bits on thermostat display 40 corresponding to symbols (such as symbols 14 shown in FIG. 1) on thermostat display 40 that represent the data gathered from the inputs such as memory 22, UI 24, and sensor 26.

The symbols displayed on display 40 may be seven-segment display characters, alpha-numeric characters, and/or icons, and represent information such as indoor temperature, outdoor temperature, time, date, day of the week, heating set point, cooling set point, on/off indicator, fan mode indicator, Fahrenheit/Celsius indicator, battery strength indicator, a sleep mode indicator, AM/PM indicator, and a hold indicator.

External interface 32 may be in the form of a serial port such as a Universal Serial Bus (USB) port, an Ethernet port, and/or a wireless transceiver. External interface 32 may be in communication with external device 34 and/or network 36. External device 34 may be a billboard, a personal computer, a hand held computer, or a cellular phone. A billboard is defined as any viewing screen larger than an average computer screen. A billboard may be beneficial for the visually impaired, training seminars, and the like. Network 36 may be private or public, wired or wireless such as corporate WAN or LAN or Internet. Network 36 may be in communication with external device 34.

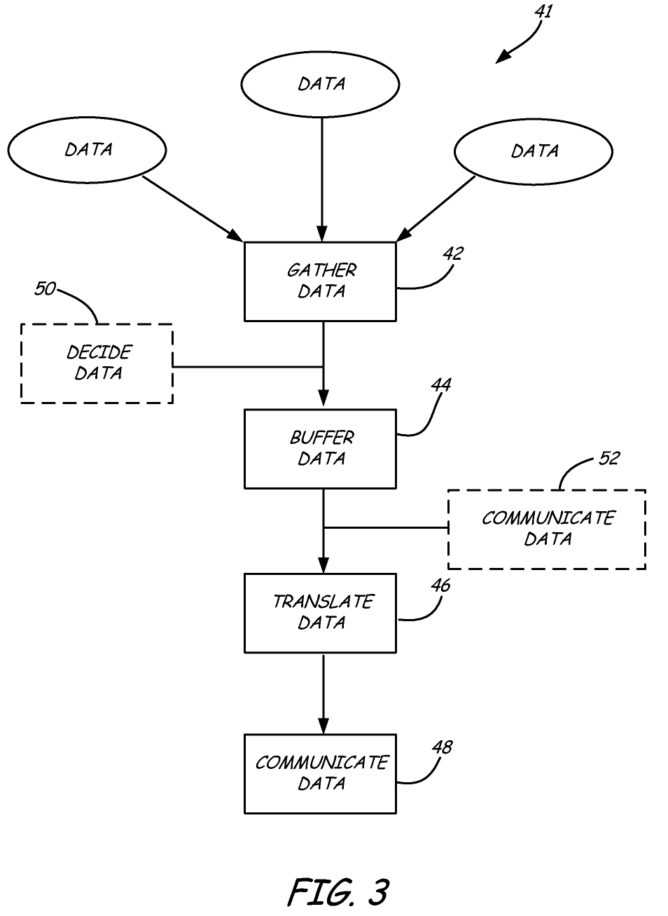

The thermostat system depicted in FIG. 2 and described above utilizes virtual display buffer 20b to buffer data in a highly readable format. For example, the buffered data may be coded in American Standard Code for Information Interchange (ASCII) or the like. Data buffered in virtual display buffer 20b may be used by engineers to develop and debug display symbols and formatting independent of the specific context of display 40. For example, data buffered in virtual display buffer 20b may be communicated to external interface 32. External interface 32 may communicate with network 36, which is Internet. Internet could be in communication with external device 34, which is a personal computer. An application on the personal computer, such as visual basic, may interpret the data and reproduce a graphical representation of the thermostat display on a remote computer screen. The components of the thermostat system may be further understood through the method depicted in FIG. 3.

FIG. 3 is a block diagram of method 41 for controlling a thermostat display in accordance with the present invention, which includes gathering data from at least one input (step 42), buffering data in a first format (step 44), translating data into a second format (step 46), and communicating data in the second format to the thermostat display to display one or more symbols based on the data (step 48). Data may be gathered from a number of inputs including an ambient condition sensor, a user interface, software alerts, and stored settings. If data is gathered from more than one input, the multiple inputs may thereby compete for the same space on the thermostat display. In the event that more than one input competes to have data displayed, method 41 includes the step of deciding which input data to display (step 50). Deciding data 50 is a resolving step whereby microprocessor 20 decides which input takes precedence and becomes the data to be buffered (step 44). Data in the first format may be sent to an external interface via communicate data 52. The external interface may take any of the forms with reference to FIG. 2. Method 41 for controlling a thermostat display utilizes a virtual display buffer to buffer data in a first format (step 44). Buffering data in a first format (step 44) allows for product development and debugging independent of a specific LCD and also allows data to be communicated to an external interface (step 52) for remote use.

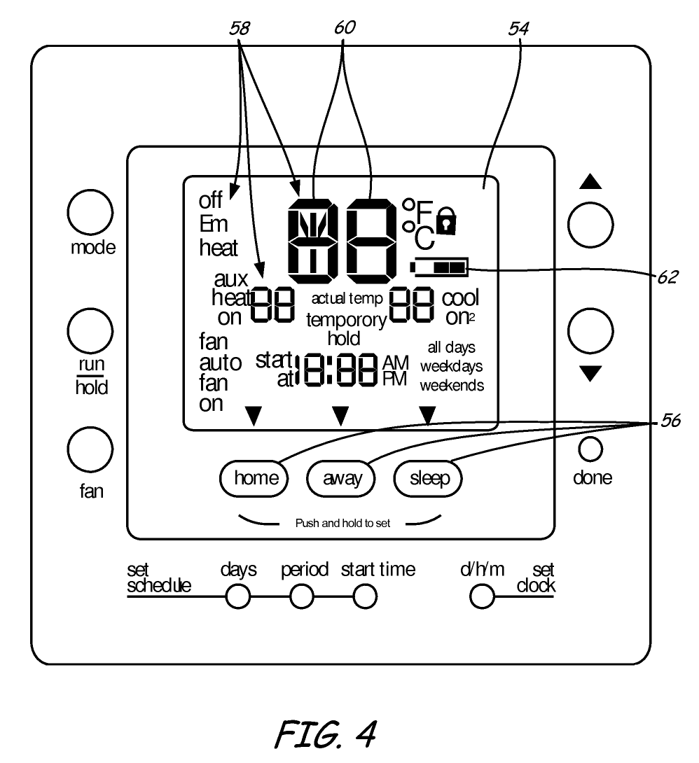

FIG. 4 depicts a plan view of thermostat display 54 and touch sensitive buttons 56 where the front covered has been removed. Thermostat display 54 includes a plurality of symbols 58 for displaying data to a user. Thermostat display 54 may use seven segment characters 60 to display outdoor temperature, indoor temperature, time, date, heating set point and cooling set point. Thermostat display 54 may use icons 62 to indicate whether the thermostat is off or on, the fan mode, whether the thermostat is in Fahrenheit or Celsius, battery strength indicator, sleep mode, whether the time is in AM or PM, and whether the thermostat is on hold. Thermostat display 54 may use alpha-numeric characters to display words such as day of the week. Also visible are touch sensitive buttons 56 which allow for a user to toggle the modes and functions of the thermostat. Buttons 56 include not only the home, away, and sleep buttons also seen in FIG. 1, but also additional buttons such as mode, run/hold, fan, up (increase) and down (decrease) which are accessible by opening the front cover of thermostat 10. FIG. 4 illustrates an example of the many symbols or icons 58 that may be present on modern thermostats and thereby, supports the need for handling thermostat data with a virtual display buffer.

While the invention has been described with reference to an exemplary embodiment(s), it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment(s) disclosed, but that the invention will include all embodiments falling within the scope of the appended claims.

1. A device comprising:
at least one input device;
a microprocessor configured to process:
an application configured to receive data from an input;
a virtual buffer configured to buffer the data in a first format; and
a display software driver configured to translate the data from the first format to a second format;
a display hardware driver for receiving the data in the second format; and
a display controlled by the display hardware driver to display one or more symbols based on the data.

3. The device of claim 1, further comprising:
an interface for controlling a system.

3. The device of claim 2, wherein the thermostat comprises two or more input devices.

4. The device of claim 3, wherein the input devices include at least one of: an ambient condition sensor, a user interface, software alerts, and stored settings.

5. The device of claim 1, further comprising:
an external interface for receiving the data in the first format.

6. The device of claim 5, wherein the external interface includes at least one of: a serial port, a universal serial bus port, an Ethernet port, and a wireless transceiver.

7. The device of claim 6, further comprising:
an external device for displaying data received from the external interface.

8. The device of claim 7, wherein the external device includes at least one of: a billboard, a personal computer, a hand held computer, and a cellular phone.

9. The device of claim 6, further comprising:
an external application for processing data received from the external interface.

10. The device of claim 9, wherein the external application includes at least one of: a remote console application, a web application, and a training application.

11. The device of claim 1, wherein the data includes ASCII characters.

12. The device of claim 1, wherein the symbols include alphanumeric characters.

13. The device of claim 1, wherein the symbols include icons.

14. The device of claim 1, wherein the display is a thermostat display.

15. A method of controlling a display, the method comprising:
gathering data from at least one input;
buffering the data in a first format;
translating the data from the first format into a second format; and
communicating the data in the second format to the display to display one or more symbols based on the data.

16. The method of claim 15, wherein gathering data from at least one input comprises gathering data from two or more inputs.

17. The method of claim 16, wherein the inputs are selected from the group consisting of: an ambient condition sensor, a user interface, software alerts, and stored settings.

18. The method of claim 17, further comprising:
deciding which data from which input will be the data buffered in a first format.

19. The method of claim 18, further comprising:
communicating the data in the first format to an external interface.

20. The method of claim 19, wherein the external interface includes at least one of: a serial port, a universal serial bus port, an Ethernet port, and a wireless transceiver.

21. The method of claim 20, further comprising:
processing the data from the external interface in an external application.

22. The method of claim 21, wherein the external application is at least one of: a remote console application, a web application, and a training program.

23. The method of claim 20, further comprising:
displaying the data on an external device.

24. The method of claim 23, wherein the external device is at least one of: a billboard, a personal computer, a hand held computer, and a cellular phone.

25. The method of claim 15, wherein the data includes ASCII characters.

26. The method of claim 15, wherein the symbols include alphanumeric characters.

27. The method of claim 15, wherein the symbols include icons.

28. The method of claim 15, wherein the display is a thermostat display.
